(19) United States
(12) Patent Application Publication
(10) Pub. No.: US 2025/0020589 A1
(43) Pub. Date: Jan. 16, 2025

(54) METAMATERIAL FOR ENHANCED VIBRATIONAL CIRCULAR DICHROISM SENSOR AND APPLICATIONS OF THE SAME

(71) Applicant: National University of Singapore, Singapore (SG)

(72) Inventors: Cheng XU, Singapore (SG); Zhihao REN, Singapore (SG); Chengkuo LEE, Singapore (SG)

(73) Assignee: National University of Singapore, Singapore (SG)

(21) Appl. No.: 18/768,609

(22) Filed: Jul. 10, 2024

(30) Foreign Application Priority Data
Jul. 10, 2023 (SG) 10202301962T

(51) Int. Cl. G01N 21/552; G01N 21/19; G01N 21/21; G01N 21/35

(52) U.S. Cl. CPC G01N 21/554; G01N 21/19; G01N 21/35; G01N 2021/216

(57) ABSTRACT

A metasurface uses pairs of nanorod plasmonic resonators that are arranged perpendicular to each other and have an in-plane asymmetry and an out-of-plane asymmetry in their geometric arrangement. The metasurface can be used to provide chirality sensor that provides an enhanced vibrational circular dichroism signal. The sensor can be used in various different molecule-sensing applications.

### CROSS-REFERENCE TO RELATED APPLICATIONS

This application claims benefit under 35 U.S.C. § 119(a) of Singapore Application No. 10202301962T filed Jul. 10, 2023, the contents of which are incorporated herein by reference in their entirety.

### TECHNICAL FIELD

The current disclosure relates to a metamaterial, and in particular to a metamaterial that can be used as a vibrational circular dichroism sensor having various applications.

### BACKGROUND

Vibrational circular dichroism (VCD) can be used to study molecules in solution. VCD detects differences in the attenuation of left and right circularly polarized light passing through a sample. Traditional VCD methods require a large amount of sample volume in order to detect the relatively weak VCD signal.

Further, while existing VCD sensors and techniques can detect the difference in the attenuation of left and right circularly polarized light, they have not been able to detect chiral mixtures of unlabeled samples.

An additional, alternative and or improved VCD technique is desired.

### SUMMARY

In accordance with the present disclosure there is provided a metamaterial for use in a sensor comprising: a substrate; and a pair of nanorod resonators that work at mid-infrared wavelengths, each of the nanorod resonators of the pair of nanorod resonators arranged perpendicular to each other on the substrate, wherein the pair of nanorod resonators have an out-of-plane asymmetry in their geometric arrangement and an in-plane asymmetry in their geometric arrangement.

In a further embodiment of the metamaterial, the out-of-plane asymmetry is a difference in a height above the substrate of the nanorod resonators of the pair of nanorod resonators.

In a further embodiment of the metamaterial, the in-plane asymmetry is an offset of the relative location of the nanorod resonators of the pair of nanorod resonators.

In a further embodiment of the metamaterial, the substrate comprises: a silicon (Si) layer; a gold (Au) layer on the Si layer; and an aluminum oxide (Al2O3) layer on the Au layer.

In a further embodiment of the metamaterial, the nanorod resonators are made from gold.

In a further embodiment of the metamaterial, comprising a second pair of nanorod resonators arranged to form a ring with the first pair of nanorod resonators.

In accordance with the present disclosure there is further provided a vibrational circular dichroism sensor comprising: a metamaterial as described above, wherein the in-plane and out-of-plane asymmetries of the metamaterial provide asymmetric absorption of circularly polarized light.

In accordance with the present disclosure there is further provided a vibrational circular dichroism sensor comprising: a metamaterial comprising first and second pairs of nanorods described above, wherein the first and second pairs of the nanorod resonators of the metamaterial provide a near-zero circular dichroism response.

In accordance with the present disclosure there is further provided a use of a vibrational circular dichroism sensor for protein secondary structure sensing.

In accordance with the present disclosure there is further provided a use of a vibrational circular dichroism sensor of with first and second pairs of nanorods for enantiomer sensing.

### BRIEF DESCRIPTION OF THE DRAWINGS

In the accompanying drawings, which illustrate one or more example embodiments:

FIG. 1 depicts a sensor formed from a metamaterial having both in-plane and out-of-plane asymmetries;

FIG. 2A depicts the wavelength absorption and molecular CD signal in the UV, visible, and NIR regimes

FIG. 2B depicts the absorption and molecular CD sensing signal in the MIR regimes

FIG. 3A depicts a chiral sensor without using the chiral metamaterial;

FIG. 3B depicts a chiral sensor using the chiral metamaterial of FIG. 1;

FIG. 4A depicts a scanning electron microscope image of the metamaterial depicted in FIG. 1. FIG. 4B depicts an atomic force microscopy image of the metamaterial depicted in FIG. 1. FIG. 4C depicts simulated field enhancements of the metamaterial depicted in FIG. 1 for the x-y plane. FIG. 4D depicts simulated field enhancements of the metamaterial depicted in FIG. 1 for the x-z plane;

FIG. 5A depicts the experimental sensing results for SEIRA spectroscopy;

FIG. 5B depicts the experimental sensing results for SEVCD spectroscopy;

FIG. 6A depicts a two port TCMT model of the metamaterial of FIG. 1;

FIG. 6B depicts the reflective circular dichroism (Rcd);

FIG. 6C depict graphs of ξ and Δγₐ/γᵣ of the metamaterial of FIG. 1;

FIG. 7A depicts a graph of experimental results of chiral metamaterials having varied ΔH;

FIG. 7B depicts simulated results of the circular dichroism with varied ΔH and ΔY;

FIG. 7C depicts a graph of experimental results of chiral metamaterials having varied ΔY;

FIG. 8A depicts a schematic of the protein IR sensing;

FIG. 8B depicts experimental results of BSA on a metamaterial of FIG. 1;

FIG. 8C depicts experimental results of β-lactoglobulin on a metamaterial of FIG. 1;

FIG. 9A depicts four schematics of protein CD sensing;

FIGS. 9B-9E depict experimental results of BSA and β-lactoglobulin on metamaterials;

FIG. 10A depicts experimental results of the ΔR signal on different chiral metamaterials;

FIG. 10B and FIG. 10C depict the simulated near field enhancement for different metamaterials;

FIG. 10D depicts experimental results of the ΔΔA signal on different chiral metamaterials;

FIG. 10E and FIG. 10F depict the simulated average chiral enhancement for different metamaterials;

FIGS. 11A-11F depict experimental results for the characterization of proteins with varying concentrations;

FIGS. 12A-12F depict experimental results for chiral mixture sensing;

FIG. 13A depicts a quasi-achiral-metamaterial sensor structure;

FIG. 13B depicts a TCMT illustration of the quasi-achiral-metamaterial design;

FIG. 13C depicts near-field simulation results of the quasi-achiral-metamaterial;

FIG. 13D depicts a measured reflection spectrum of an L-ring metamaterial; and

FIGS. 14A-14D depict results for sensing of L-glucose and D-glucose using quasi-achiral-metamaterial sensors.

### DETAILED DESCRIPTION

A metamaterial formed with chiral plasmonic resonator structures can be used as a chirality sensor that can detect and enhance vibrational circular dichroism signals for molecules, including biomolecules. As described in further detail below, the metamaterial may have a pair of nanorod plasmonic resonators that are perpendicularly arranged on a substrate in order to have asymmetries in both the in-plane and out-of-plane geometries. The in-plane asymmetry may be an offset of one of the nanorod resonators relative to the other, while the out-of-plane asymmetry may be a difference in the height of the two nanorod resonators. The determination of the in-plane and out-of-plane symmetries are described in further detail below. A vibrational circular dichroism sensor using the metamaterial described herein can enhance the vibrational circular dichroism signal be a magnitude of approximately 6 times. Such a sensor can be used for sensing down to a zeptomole level and as such can still work with an ultra-small volume of a sample. The sensor using the metamaterial can be used for the detection of chiral mixtures without requiring the samples be labeled. Further, a metamaterial based on the asymmetric pairs of nanorods can provide a sensor with a quasi-achiral sensor, which has a chiral structure but has a near-zero chiral dichroism (CD) response.

As described further below a chirality sensor is provided that detects and enhances the vibrational circular dichroism signal using plasmonic chiral metamaterials or surfaces. Two types of sensors are described using the same basic metamaterial features. The first sensor type is a chiral metamaterial sensor that has two perpendicularly positioned nanorods with both planar and vertical designed asymmetric structures. The metamaterial of this sensor provides asymmetric absorption of circularly polarized light. The second sensor type uses a similar metamaterial, however rather than based on a pair of nanorods the metamaterial of the second sensor uses two pairs of nanorods to provide a quasi-achiral metamaterial sensor, which has a chiral structure but with a near-zero CD response. Advantageously, the metamaterials can be directly fabricated using a standard lithography process, which makes sensors using the metamaterials suitable for large-scale production.

The sensors described herein can be used in a wide range of sensing applications, some of which are described further below. One sensing application is protein secondary structure sensing. In such an application, the sensor is coated with proteins with secondary structures, and the chiral metasurface of the sensor detects both the infrared absorption signal as well as well as the circular dichroism. A label-free chiral mixture sensing process in the mid-infrared regime can be provided by combining these two signals. Leveraging such a sensing platform, the vibrational circular dichroism signal was enhanced by 6 magnitudes, which corresponds to zeptomole-level sensing of molecular chirality.

Sensors based on the metamaterials described herein can be used to improve the sensitivity of the sensor. In traditional VCD methods, the weak vibrational circular dichroism signal requires a large amount of sample volume to be detected. Using sensors described herein, the signal is enhanced by 6 magnitudes, which can reduce the volume of the sample needed, and possibly reducing costs. Further, sensors based on the metamaterials can provide new applications. In drug production or chemical synthesis process, a byproduct can be the enantiomer of the targeted product, which presents opposite chirality and can result in undesired side effects. The sensor described herein enables the detection of molecular chirality in mixtures, and therefore can detect the presence of the possibly undesirable enantiomers.

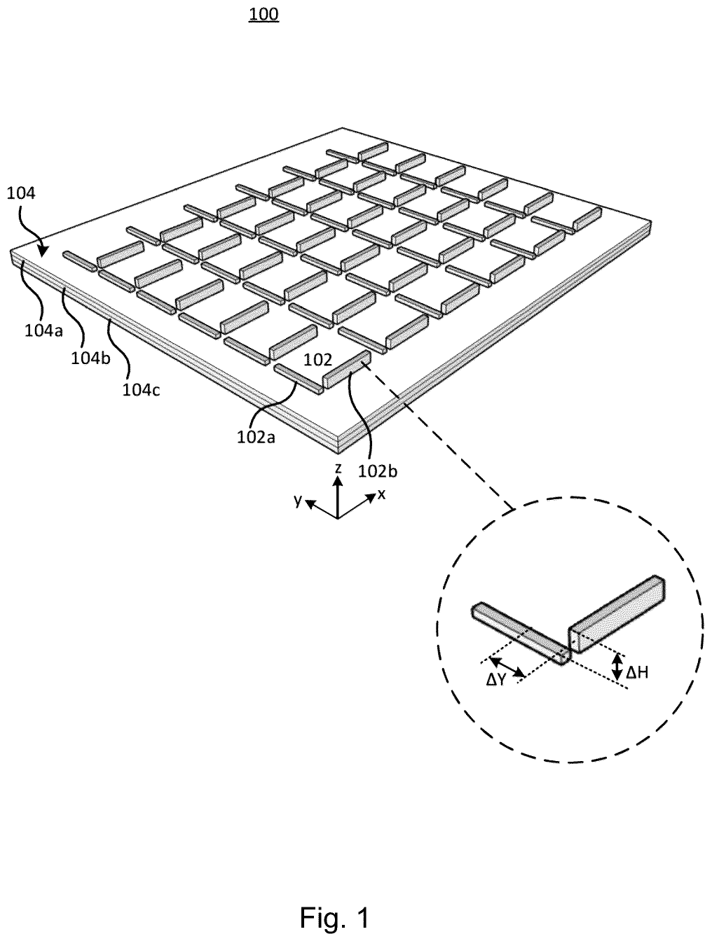

FIG. 1 depicts a metamaterial having both in-plane and out-of-plane asymmetries used for a sensor. The metamaterial may be referred to as infrared chiral plasmonic metamaterials (IRCPMs). The metamaterial 100 comprises a plurality of chiral structures 102 arranged on a substrate 104. Each of the chiral structures comprise a pair of perpendicularly arranged nanorod plasmonic resonators 102a, 102b. Each of the chiral structures comprise both in-plane and out-of-plane asymmetries in the geometric arrangement of the structure. It is noted that with regard to in-plane and out-of-plane, the plane is the plane of the substrate 104 the chiral structures are arranged on. The in-plane asymmetry is an offset in the position ΔY of one of the nanorods relative to the other. The offset is along an axis, such as the y axis, that the perpendicular nanorods are arranged relative to. The out-of-plane asymmetry is a difference of height ΔH of the nanorods. The substrate 104 comprises an aluminum oxide layer 104a, a gold layer 104b and a silicon layer 104c.

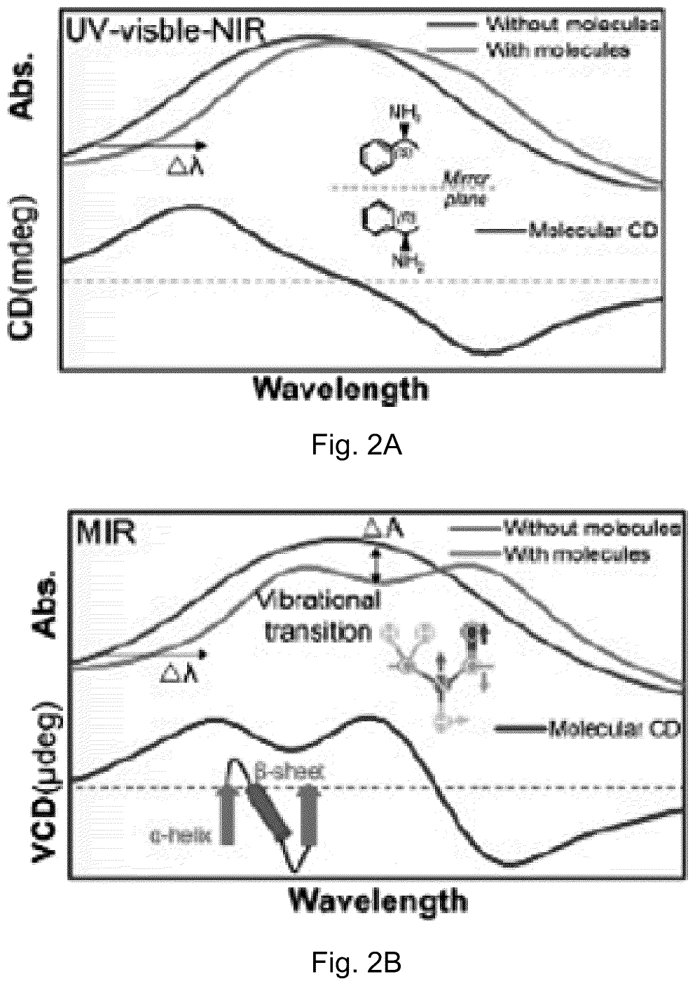

The enhancing mechanism of VCD sensing uses reflective chiral metamaterials consisting of two orthogonal resonant modes. After analyzing the interaction between molecules and the near field coupling between these resonant structures, the structure can be further optimized for retrieving an enhanced far field molecule signal. Such a metamaterial platform can be leveraged as biosensor for sensing protein secondary structures. The difference between traditional CD in UV-visible-NIR ranges and vibrational CD in MIR regime is shown in FIGS. 2A and 2B. FIG. 2A depicts the wavelength absorption and molecular CD signal in the UV, visible, and NIR regimes. The absorption peak of chiral molecules shows the wavelength redshift. The molecular signal (bottom curve) after removing the background signal indicates the molecular chirality, such as (S)-1-phenylethylamine and (R)-1-phenylethylamine. FIG. 2B depicts the absorption and molecular CD sensing signal in the MIR regimes. In addition to the wavelength shift, sensing in the MIR regime can also provide vibrational transition of molecules. The relevant VCD signal could provide both vibration and chirality information, such as amide I vibration and secondary structures of proteins.

Traditional absorptive CD spectrum detects the wavelength shift Δλ when the sensors are coated with chiral molecules. After removing the background signal of the sensors, the molecular chirality can be recognized from the sign of the CD spectra. The signal level of typical enantiomers like (S)-1-phenylethylamine and (R)-1-phenylethylamine are around mdeg level. Unlike CD in short wavelength, mid-IR VCD spectroscopy not only illustrates molecular chirality, but also reveals the vibrational transition ΔA. Equipped with the multidimensional spectroscopic information, complex biomolecules structures can be effectively detected, such as amide I, amide II vibrations and secondary structures of proteins. However, the intrinsic VCD signal without enhancement is weak, which is only around μdeg level.

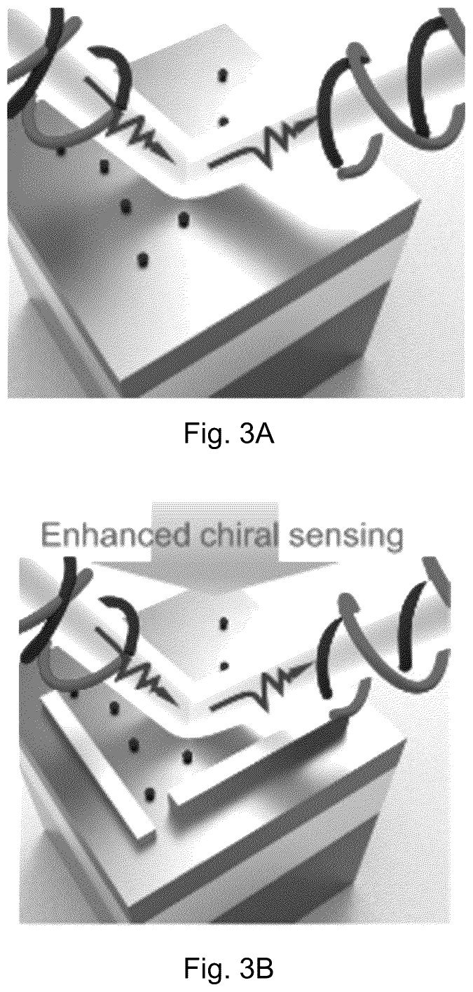

The infrared chiral plasmonic material (IRCPM) platform for enhancing the VCD signal is shown in FIG. 1 and can be incorporated into a surface-enhanced vibrational circular dichroism (SEVCD) chip. The SEVCD metamaterial chip can made by integrating gold nanorods on top of the Al₂O₃—Au—Si substrate. The single Au nanoantenna was fabricated at the size of 1.7 μm×0.4 μm through a two-step lithography process followed by deposition of different thicknesses of Au, and the Al₂O₃—Au layer is deposited on a dummy Si substrate. The different thicknesses of Au of the nanorods were 200 nm and 100 nm. The chiral metamaterials coated with D- and L-chiral molecules present asymmetric signal absorption when LCP and RCP light are impinged onto the structures. As the bottom Au layer functions as a reflector, the incident light is either absorbed by the nanostructures or reflected to free space. Hence, by reading the reflection spectrum only, the absorption spectrum can be calculated as A=1−R, where R and A represent the reflection and absorption coefficients. Leveraging the chiral metamaterials described herein, the reflective molecule signals are effectively enhanced by enlarging the absorption difference of the circularly polarized light, as shown in FIGS. 3A, 3B. FIG. 3A depicts a chiral sensor without using the chiral metamaterial. The chiral sensor of FIG. 3A comprises the substrate of aluminum oxide-gold-silicon, however does not include the chiral nanorods. FIG. 3B depicts a chiral sensor using the chiral metamaterial of FIG. 1. The chiral nanorods of the metamaterial can provide enhanced chiral sensing of several orders of magnitude compared to a sensor without the chiral nanorods.

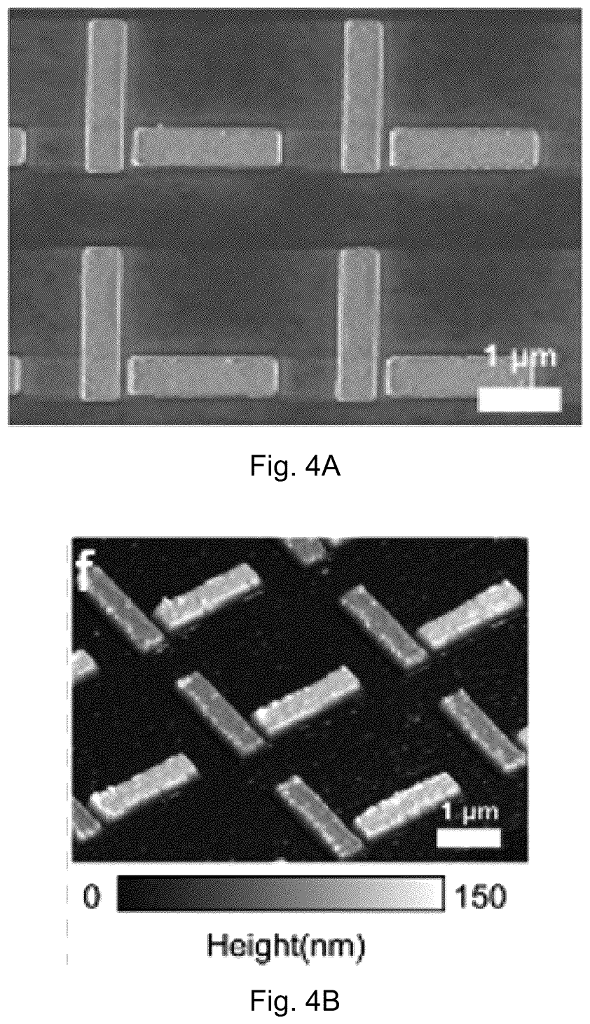

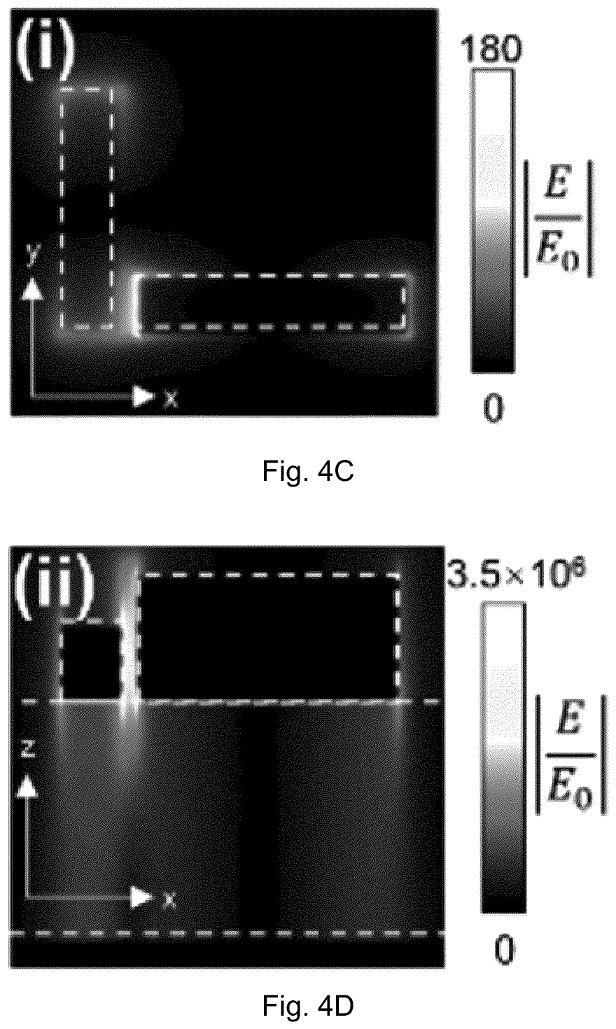

For better enhancing the chiral signals, two geometric factors were varied, labelled ΔH and ΔY, which indicates the out-of-plane and in-plane asymmetries, respectively. The AFM and SEM image of the proposed IRCPM structures are shown in FIGS. 4A, 4B, where different colors of these two nanorods indicate different deposition thicknesses of gold. FIG. 4A depicts a scanning electron microscope image of the metamaterial depicted in FIG. 1. FIG. 4B depicts an atomic-force microscopy image of the metamaterial depicted in FIG. 1. The height, or thickness, of one of the nanorods is 85 nm and the height, or thickness, of the other nanorod is 108 nm.

FIG. 4C depicts simulated field enhancements of the metamaterial depicted in FIG. 1 for the x-y plane and FIG. 4D depicts simulated field enhancements of the metamaterial depicted in FIG. 1 for the x-z plane. The simulated wavenumber for the simulations of FIGS. 4C, 4D is 1650 cm⁻¹ The near field simulation results illustrates that both in-plane and out-of-plane field enhancement is generated, where a strongest field confinement is observed in the nanogap region, which enables larger field intensity experienced by the molecules. To characterize the differences of the enhanced molecule signals with the removed signal of the chiral metamaterial background, two parameters are defined, determined as:

$$Δ R = {R}_{w . molecule} - {R}_{w / o . molecule} \qquad ( 1 )$$

$$ΔΔ A = Δ {A}^{w . molecule} - Δ {A}^{w / o . molecule} \qquad ( 2 )$$

Where the subscript w. molecule and w/o. molecule represent with molecule and without molecule, respectively. The absorption difference ΔA is determined by:

$$Δ A = {A}_{LCP} - {A}_{RCP} \qquad ( 3 )$$

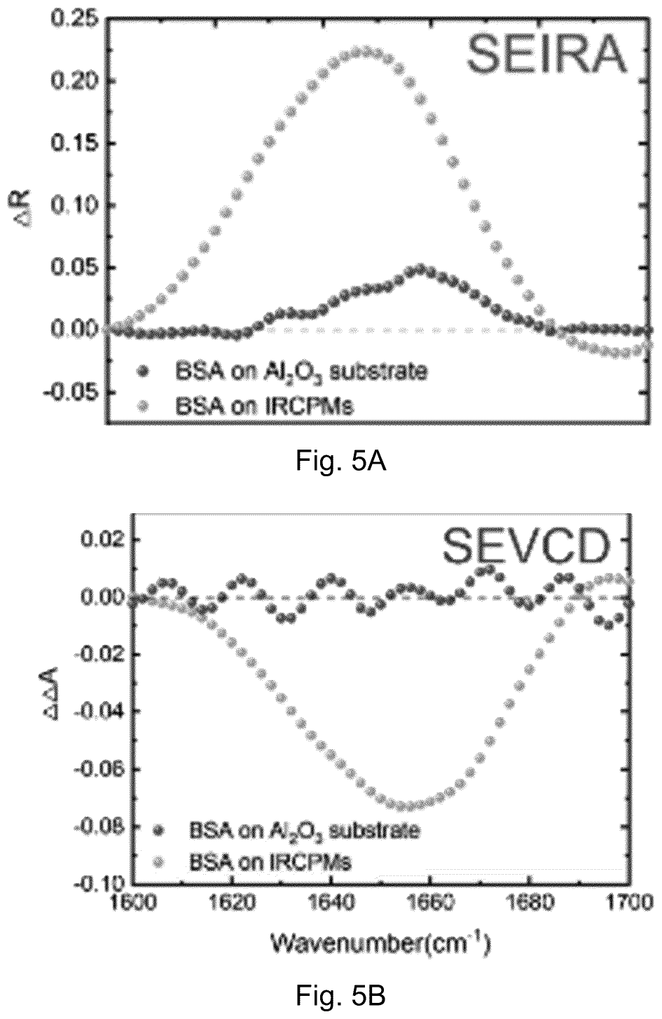

Leveraging these two parameters, the enhanced molecule sensing signal was measured for both IR and CD spectra, as shown in FIGS. 5A, 5B. FIG. 5A depicts the experimental sensing results for surface-enhanced IR absorption (SEIRA) spectroscopy and FIG. 5B depicts the experimental sensing results for surface-enhanced vibrational circular dichroism (SEVCD) spectroscopy. FIGS. 5A and 5B depict results for BSA sensing using both a substrate only sensor such as depicted in FIG. 3A and an IRCPM enhanced sensor such as depicted in FIG. 3B. For both SEIRA and SEVCD spectroscopy, compared with molecule signal on Al2O3 substrate, the signal is significantly improved when coated on IRCPMs.

Coated with BSA proteins, the molecule signal using the Al₂O₃ substrate without the IRCPM enhancement approaches zero for two spectra, which is difficult to identify the BSA vibrational mode and its chirality, as shown in the lower curves in FIGS. 5A, 5B. Fortunately, with the IRCPMs structures, both two molecule signals are amplified, which shows an amide I vibration around 1650 cm⁻¹, and a negative chirality signal indicating the α-helical secondary structure. Such results indicate an effective and promising enhancement for both SEIRA and SEVCD spectroscopy.

The design and optimization framework of the chiral metamaterial is further described below. The resonant plasmonic structures could interact with light at certain wavelengths, forming a coupling system. In such a system, the radiative and absorption loss plays essential roles in the far-field spectrum. The IRCPM described herein provides an approach to manipulating the absorption of circularly polarized light by tuning both the in-plane and out-of-plane asymmetric factors of the structures.

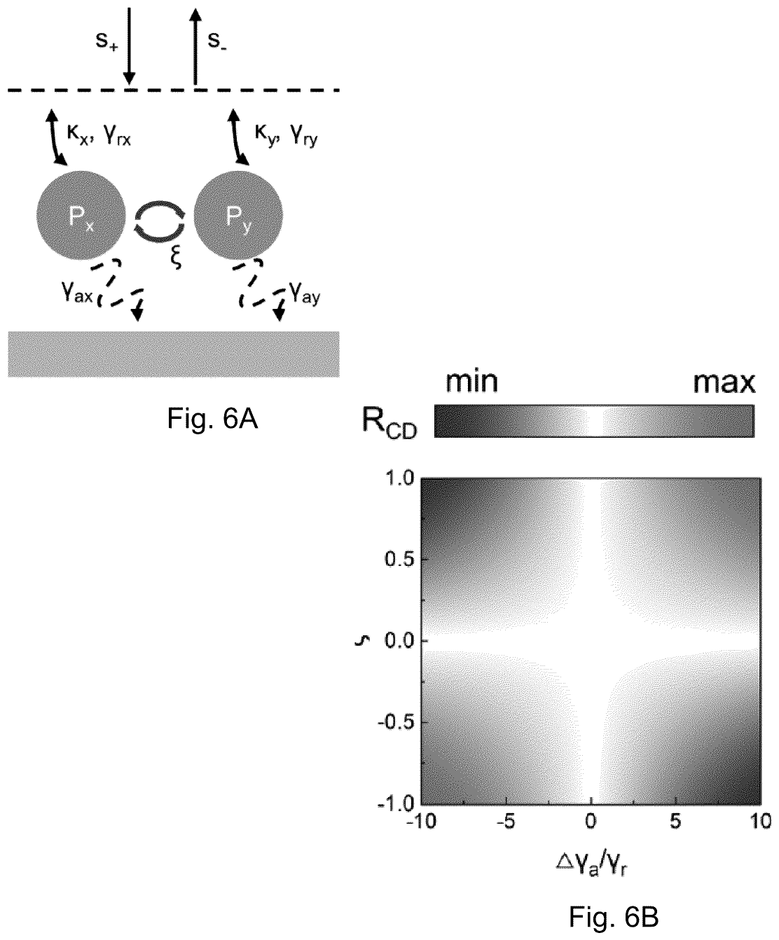

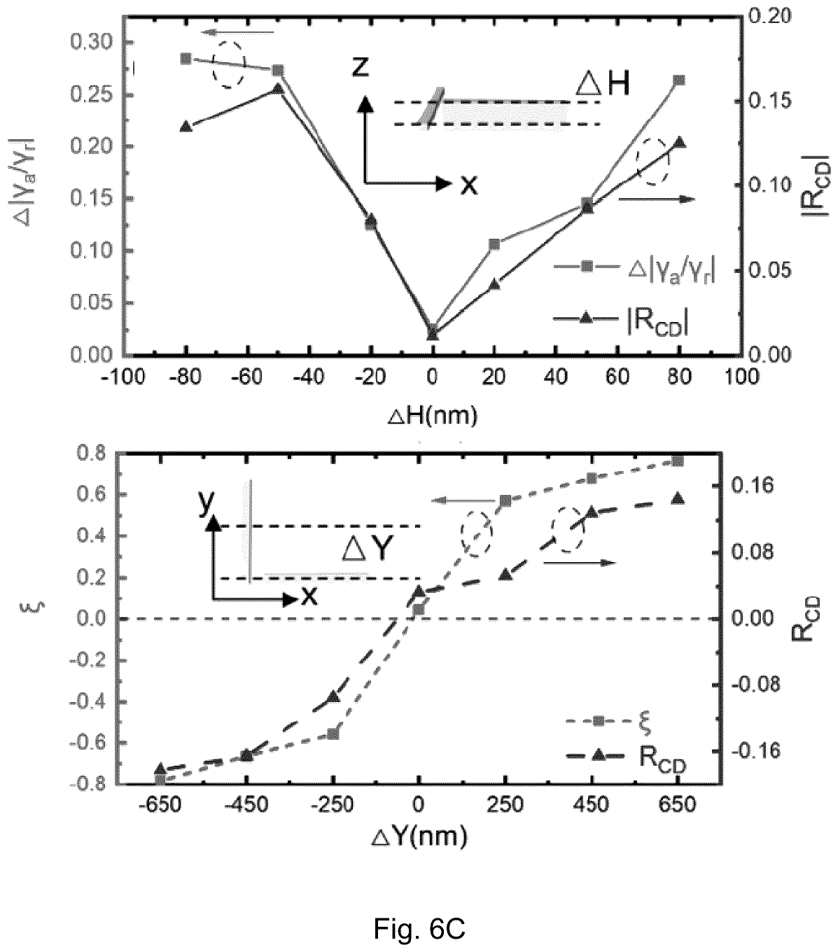

To illustrate the design principles, TCMT is used to analyze the coupling system. The two port schematic of the TCMT model is shown in FIG. 6A. The design is originated from double nanorod structures which are positioned perpendicularly, the model can be expressed as a two-port coupling system:

$$\begin{matrix}\frac{d}{dt} ( \begin{matrix}{P}_{x} \\ {P}_{y}\end{matrix} ) = j ( \begin{matrix}{ω}_{x} & 0 \\ 0 & {ω}_{y}\end{matrix} ) ( \begin{matrix}{P}_{x} \\ {P}_{y}\end{matrix} ) - ( \begin{matrix}{γ}_{rx} + {γ}_{ax} & j ξ \\ j ξ & {γ}_{ry} + {γ}_{ay}\end{matrix} ) ( \begin{matrix}{P}_{x} \\ {P}_{y}\end{matrix} ) + ( \begin{matrix}{κ}_{x} & 0 \\ 0 & {κ}_{y}\end{matrix} ) ( \begin{matrix}{s}_{x}^{+} \\ {s}_{y}^{+}\end{matrix} ) & ( 4 ) \\ ( \begin{matrix}{s}_{x}^{-} \\ {s}_{y}^{-}\end{matrix} ) = ( \begin{matrix}- 1 & 0 \\ 0 & - 1\end{matrix} ) ( \begin{matrix}{s}_{x}^{+} \\ {s}_{y}^{+}\end{matrix} ) + ( \begin{matrix}{κ}_{x} & 0 \\ 0 & {κ}_{y}\end{matrix} ) ( \begin{matrix}{P}_{x} \\ {P}_{y}\end{matrix} ) & ( 5 ) \\ {( \begin{matrix}{s}_{x}^{+} \\ {s}_{y}^{+}\end{matrix} )}^{LCP} = \frac{1}{\sqrt{2}} ( \begin{matrix}1 \\ j\end{matrix} ) , {( \begin{matrix}{s}_{x}^{+} \\ {s}_{y}^{+}\end{matrix} )}^{RCP} = \frac{1}{\sqrt{2}} ( \begin{matrix}1 \\ - j\end{matrix} ) & ( 6 )\end{matrix}$$

where Pₓ and P_{y} are the mode amplitude of the plasmonic structure, ωₓ and ω_{y} are the resonance frequency of the plasmonic structures oriented along the x and y axis, respectively. The radiative and absorptive losses are denoted as γᵣ and γₐ, while the near field coupling coefficient between two resonances is written as ξ. R denotes the reflection spectrum, which is related to the amplitude of incident light (S⁺) and reflected light (S⁻). The far-field coupling coefficient is represented as κ. As the whole model is a two-port reflective coupling system, κ can be defined as \sqrt{2γᵣ}. The reflective circular dichroism (R_{CD}) can be obtained as:

$${R}_{CD} = \frac{4 ξ ( \frac{{γ}_{ay}}{{γ}_{ry}} - \frac{{γ}_{ax}}{{γ}_{rx}} ) {( {γ}_{rx} {γ}_{ry} )}^{\frac{3}{2}}}{{\vert {ξ}^{2} + [ j ( {ω}_{0} - {ω}_{x} ) + {γ}_{rx} + {γ}_{ax} ] [ j ( {ω}_{0} - {ω}_{y} ) + {γ}_{ry} + {γ}_{ay} ] \vert}^{2}} \qquad ( 7 )$$

From the numerator of the expression of RCD, two terms mainly determine the sign of CD, which are near-field coupling coefficient ξ, and the different ratio between the absorptive and radiative losses, denoted as

$$Δ \frac{{γ}_{a}}{{γ}_{x}} = \frac{{γ}_{ay}}{{γ}_{ry}} - \frac{{γ}_{ax}}{{γ}_{rx}} .$$

The relevant RCD are calculated with varied ξ from −1 to 1 and varied

$$Δ \frac{{γ}_{a}}{{γ}_{r}}$$

from −10 to 10, as shown in FIG. 6B.

As the nanoantennas are made of plasmonic nanorods and behave like dipoles, the absorption losses for the two modes are nearly equal. Therefore, two methods are proposed to enlarge the circular dichroism: create larger optical chirality in the near field region to change ξ or construct the geometric asymmetry with different radiation losses for larger

$$Δ \frac{{γ}_{a}}{{γ}_{r}} .$$

Both out-of-plane and in-plane geometric variation are created, where ΔH is denoted as the thickness difference between the two nanoantennas and ΔY represents the planar deviation on the y-axis. As ΔH and ΔY are enlarged, the asymmetry on planar and vertical planes is increased, creating radiative losses and near field coupling differences. This intuitive understanding is also confirmed by extracting ξ and

$$Δ \frac{{γ}_{a}}{{γ}_{r}}$$

in the TMCT model from the simulated reflection spectrum, as shown in FIG. 6C. For both factors, the circular dichroism achieves near zero value when the ξ and

$$Δ \frac{{γ}_{a}}{{γ}_{r}}$$

is approaching zero. It should be noted that only the tuning of ξ could reach zero CD value, as the mean superchiral field can be zero by tuning the ΔY into achiral structures. For

$$Δ \frac{{γ}_{a}}{{γ}_{r}} ,$$

the shape of these two nanoanatennas will be different by changing the thickness, while the planar shape is kept, which may decouple the near field interaction with the loss changes. In summary, a more intuitive understanding is that ΔH mainly controls the radiative loss of two plasmonic structures, while ΔY mainly determines the near field coupling between two orthogonal modes. This does not indicate the independent control for these two factors by varying the geometric parameters. However, leveraging this framework, the methodology for chiral sensor design can be well illustrated.

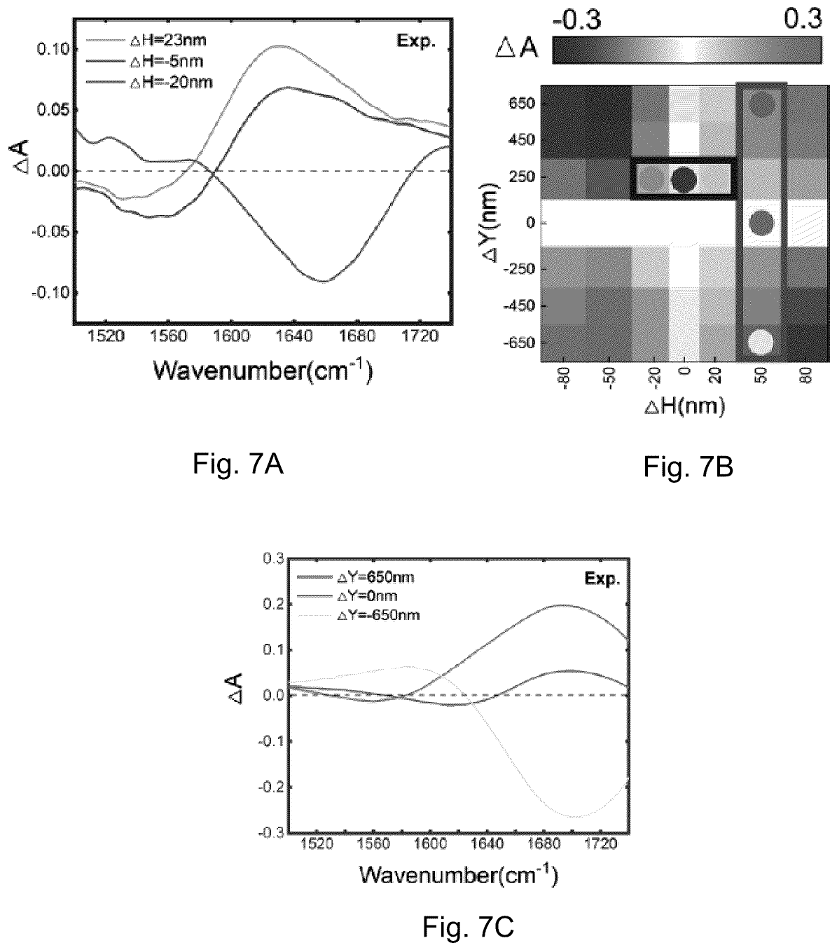

Further numerical and experimental demonstrations are made with varied ΔY and ΔH, as shown in FIGS. 7A-7C. In the simulated mapping of RCD, with varied ΔY from −650 nm to 650 nm and varied ΔH from −80 nm to 80 nm, the RCD presents similar hyperbolic-like distribution, which assembles the parameter mapping in 6B. This further illustrates the influence by the loss and near-field coupling. When ΔY=650 nm and ΔH=80 nm, the circular dichroism reaches the largest value of 0.3. In addition, when ΔY and ΔH are transferred from a positive value to a negative value, the CD is also turned into the opposite sign, illustrating the conversion of optical chirality. These findings were experimentally validated using fabricated devices with varied ΔY from −650 nm to 650 nm and ΔH from −23 nm to 20 nm, as the orange (middle curve at far left), purple (bottom curve at far left), and green (top curve at far left) curves shown in FIG. 7A, 7C. The results of orange and green curves are fitted well with the simulation results. However, for the purple curves where the ΔY and ΔH are close to zero, the RCD does not agree with the simulation well, which is due to the fabrication inaccuracy. It is also observable that when ΔH˜0, the RCD is nonzero, as the planar structure with nonzero ΔY is still chiral. However, the RCD becomes near zero when ΔY˜0, despite the value of ΔH. This further indicates that ΔY controls the near field coupling ξ while ΔH depends on the loss difference

$$Δ \frac{{γ}_{a}}{{γ}_{r}} ,$$

as the latter cannot reach zero value due to the asymmetry on x-axis and y-axis.

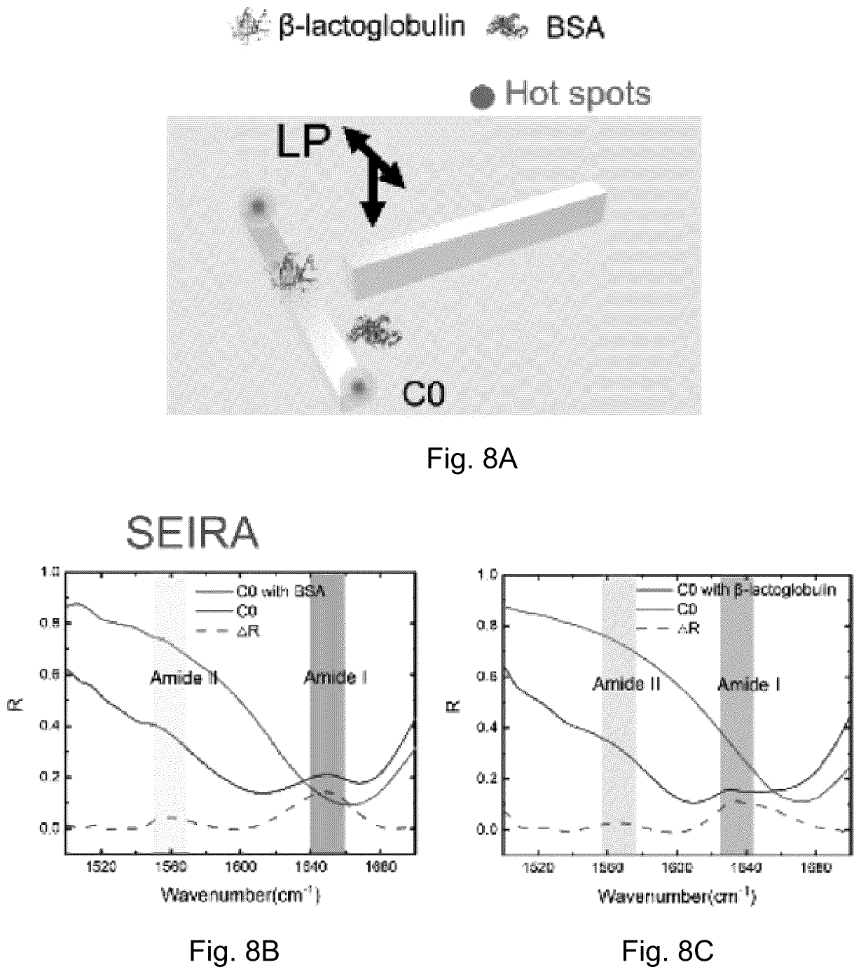

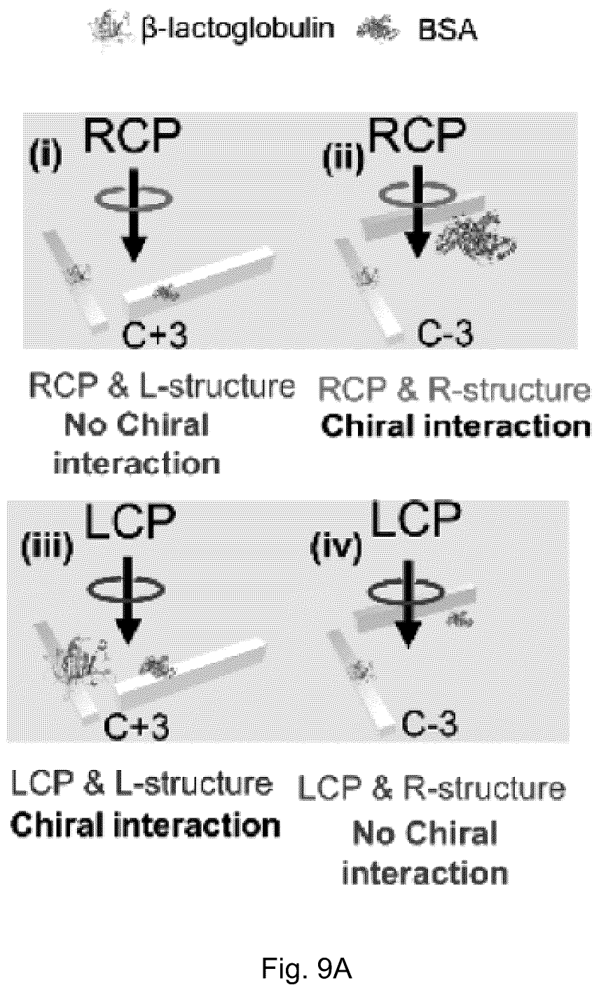

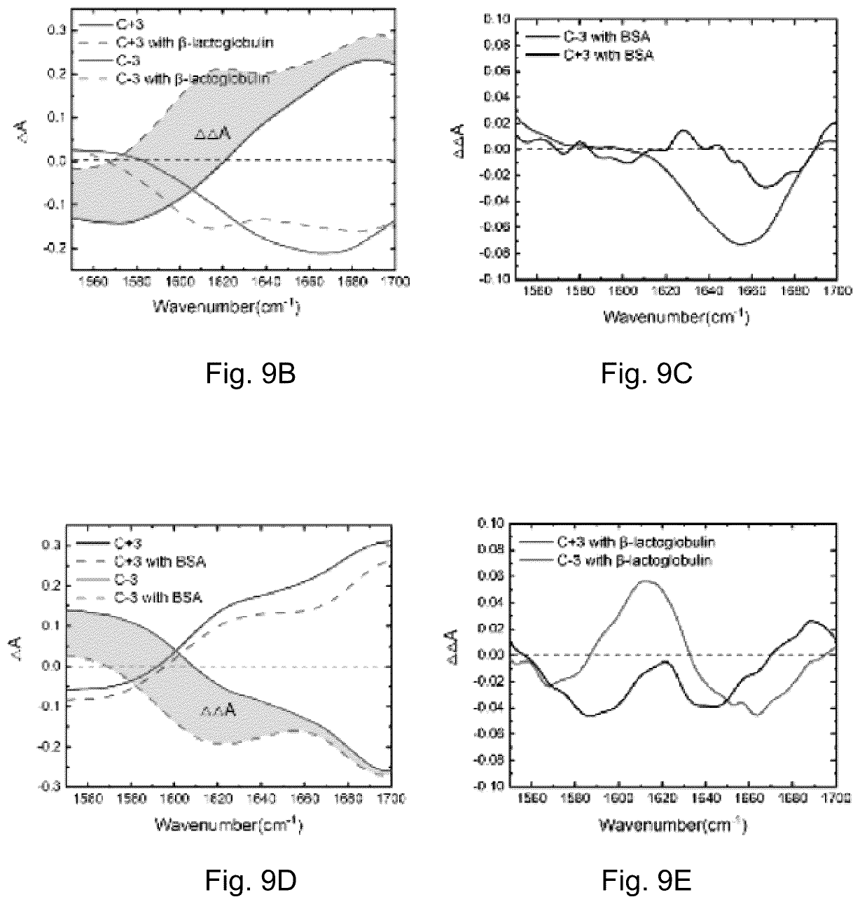

The IRCPM enhanced sensors may be used in the Enhanced VCD measurement for chiral molecules For the sensing characterization, as the planar geometric asymmetry could provide more near field coupling difference, only metamaterials with fixed thickness difference at ΔH=−50 nm were used. The structures were labeled with ΔY difference from −650 nm to 650 nm as C+3, C+2, C+1, C0, C−1, C−2, and C−3 for better illustration. To test the sensing features of the proposed chiral metamaterials, the C+3, C−3, and C0 material was used to fabricate devices to demonstrate the signal acquisition process of both SEIRA spectroscopy as highlighted in FIGS. 8A-8C and SEVCD spectroscopy as highlighted in FIGS. 9A-9E. A sample of BSA and β-lactoglobulin prepared at a concentration of 250 ng/μL in DI water was tested. A protein solution of 2 μL was used to form a thin film on the sensor for optical characterization. As the vibrational wavelengths of BSA and β-lactoglobulin solution in DI water are around 6 μm², the chiral metamaterials were used with a length of 1.7 μm that have the same resonant wavelength of the protein. The results for SEIRA spectroscopy are shown in FIGS. 8A-8C. The C0 metamaterial presents a resonant frequency near the wavenumber 1640 cm⁻¹, generating hotspots at each edge of the nanoantenna. When BSA was coated onto the surface, two reflection peaks arose at the wavenumber 1560 cm⁻¹ and 1650 cm⁻¹, indicating the vibrational mode for amide II and amide I of BSA, respectively, as the black (middle curve at far left) and red (top curve at far left) curves shown in FIG. 8B. To remove the background signal of metamaterials, these two signals were subtracted, the results is shown as the blue (bottom curve at far left) curve in FIG. 8B. Similarly, we implement the process for the β-lactoglobulin signal, as shown in FIG. 8C, where two peaks are at wavenumber 1565 cm⁻¹ and 1633 cm⁻¹. Compared to the IR signals of these two proteins, the different vibrational modes of the amide I illustrate the identity of each molecule.

For the SEVCD spectrum, the schematics showing the sensing principles are shown in FIGS. 9A-9E. Chiral structures C+3 and C−3 are used to detect the optical chirality difference as they could provide larger circular dichroism. As the absorption signal for amide II is much smaller than amide I for both proteins, while the ¼ waveplate only covers a narrow band (λ₀=6 μm, Δλ=400 nm), only the peaks for amide I were chosen for SEVCD demonstration. Coated with proteins, the C+3 structure absorbs more LCP light and has no interaction with RCP light. Hence, for β-lactoglobulin, the CD signal can be enhanced by the C+3 structure. Similarly, C−3 can enhance the CD signal for BSA. The ΔA results are shown in FIGS. 9B, 9D. It can be noticed that with the proteins, the initial CD signal showed both wavelength shift and absorption peaks, this is because of the index change by the protein thin film as well as the IR absorption signals. The signal is subtracted to remove the influence of the metamaterials. The ΔΔA results are shown in FIGS. 9C, 9E. The molecule CD signal is effectively enhanced when the chirality matches with the structural chirality. A magnified BSA signal is observed with C−3 metamaterials and magnified β-lactoglobulin signal is observed with C+3 metamaterials. Moreover, the absorption peaks agree with the IR fingerprints of these two molecules, indicating the featured information for both chiral molecules. This demonstrates the enhanced molecule signals via both SEIRA and SEVCD spectroscopy using the IRCPM enhanced sensor.

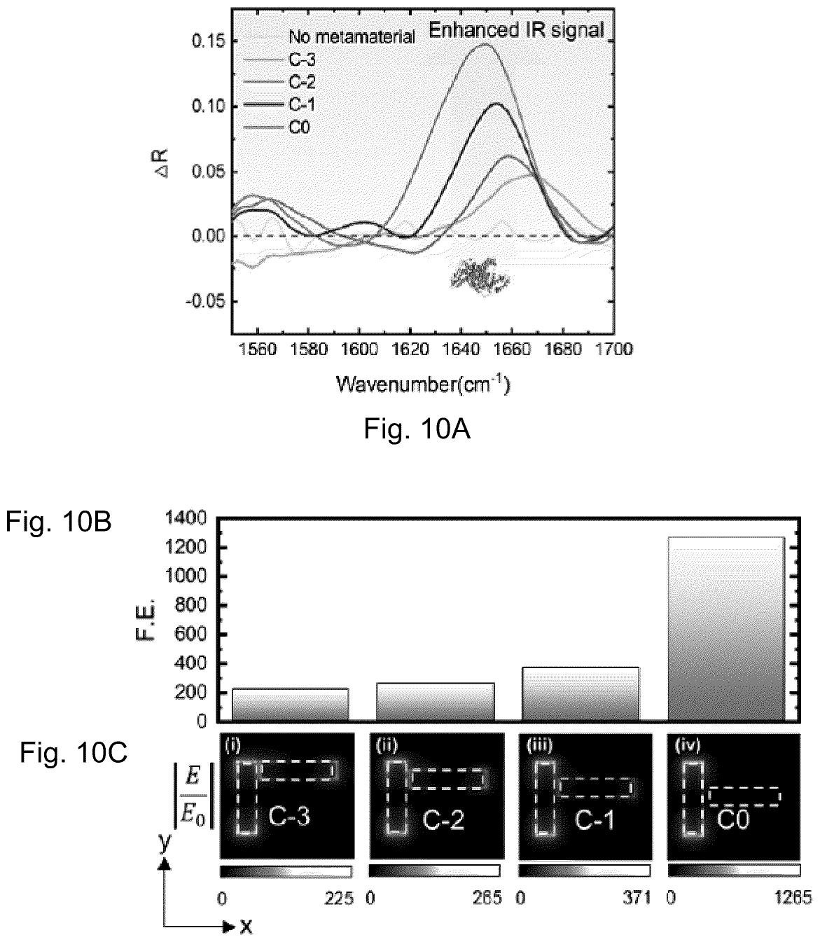

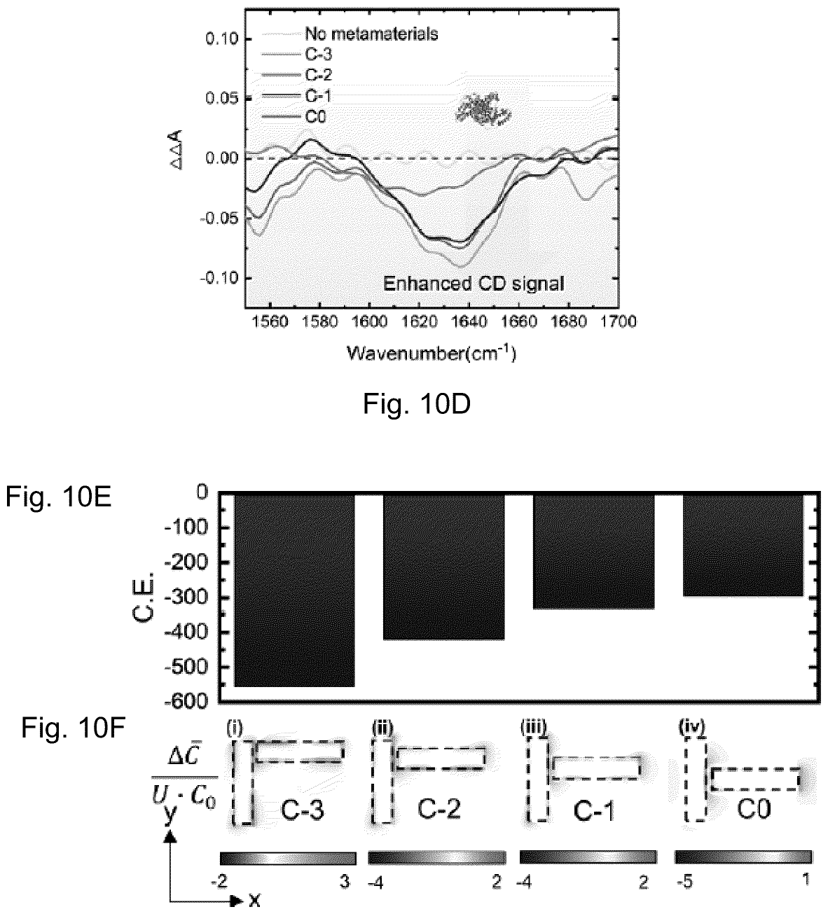

The enhancement performance for different chiral metamaterials was experimentally analyzed and compared them with the near-field simulation results to illustrate the enhancing mechanisms, as shown in FIGS. 10A-10F. All the chiral metamaterials used in this demonstration have the same gap of 100 nm, as smaller gap could provide larger sensing performance. BSA was coated onto the chiral metamaterials with a concentration of 250 ng/μL. Four different chiral metamaterials were measured to obtain both the IR absorption and CD signals, labeled C−3, C−2, C−1, and C0, as shown in FIGS. 4A, 4D. The ΔR increases when the device is varied from C−3 to C0, where C0 presented the largest signal of around 0.15. This enhanced molecule signal is 3 times larger compared with C−3 metamaterials, and around 15 times larger than the pure reflective molecule signal without being improved by any metamaterials. FDTD simulation was used to simulate the electrical near-field distribution of these four metamaterials, as shown in FIGS. 10B, 10C. As the polarization is linear along the left nanorod, the dipole moment along the y axis is generated. The field enhancement F.E. is determined by:

$$F . E . = max ( \vert \frac{E}{{E}_{0}} \vert ) \qquad ( 8 )$$

Where E₀ is the near field intensity without metamaterials. The F.E. of C0 achieved around 1265, which is 5 times larger than the C−3 metamaterial, suggesting that molecules located at such metamaterial could experience larger near-field enhancement compared with other structures. Besides, from the reflective spectrum, the C0 metamaterial has the highest Q factor for the resonant peak, indicating larger field confinement. Accordingly, the C0 structures with less asymmetry and higher field enhancement could provide the highest IR absorption signal.

For the chirality enhancement, which is different from the IR sensing results, the C−3 has the largest CD signal than the others, which agreed with the optimized results shown in FIGS. 6A-7C. The optical chirality of the four structures was also simulated. As the nanoantennas are of varied thicknesses, multiple monitors were implemented from the bottom surface to the top surface of the antenna to obtain the average optical chirality for the whole structure. The differential optical chirality is determined by:

$$\begin{matrix}{C}_{i} = - \frac{{ε}_{0} ω}{2} ( {E}_{i}^{*} \cdot {B}_{i} ) & ( 9 ) \\ \overline{C} = {\sum }_{i = 1}^{N} \frac{{C}_{i}}{N} & ( 10 ) \\ Δ \overline{C} = {\overline{C}}_{LCP} - {\overline{C}}_{RCP} & ( 11 )\end{matrix}$$

where ε₀ is the permittivity in vacuum, ω is the angular frequency of the circular polarized light, E and B are the intensities of electric and magnetic fields, respectively. The subscript i is the number of the electric field monitor, and N is the total number of the monitors along the vertical direction, which can be arbitrarily chosen depending on the thickness difference ΔH. The reason for placing multiple monitors is to calculate the total superchiral field distribution of the thickness-varied nanorod structure. As the molecules are randomly localized around the chiral metamaterials, the average value of the optical chirality was calculated as a mean superchiral field that a molecule could experience. To eliminate the influence of the field enhancement, the enhancement was divided by the total power of the plasmonic resonator, denoted as U. The determination of chiral enhancement C.E. provided by each structure is determined by:

$$C . E . = \int \int \frac{Δ \overline{C}}{U \cdot {C}_{0}} dxdy \qquad ( 12 )$$

where C₀ represents the optical chirality without the chiral metamaterials in free space. The integral denotes the total superchiral field on one unit cell, which means the chiral enhancement that molecules could experience for each unit structure. The near-field images are shown in FIG. 10E, 10F. The localized field of the C−3 structure showed the highest enhancement and asymmetry, followed by C−2 and C−1. For the C0 structure, although the field intensity is larger, the mean chirality is small and thus, difficult to interact with chiral molecules. Hence, for right-handed chiral molecule sensing, C−3 structure with larger asymmetry could provide higher enhancement of superchiral field, enabling larger molecule signal compared with other structures. Although only the results of right-handed structures are provided as a demonstration of enhanced BSA sensing, such analysis and results are also applicable for left-handed structures, where the C+3 structure has larger enhancement for enhanced β-lactoglobulin sensing.

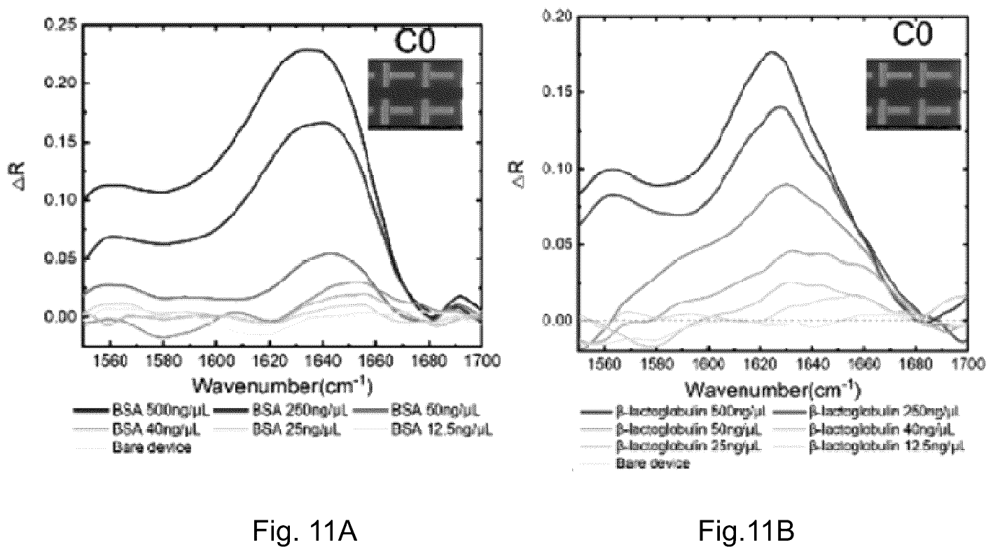

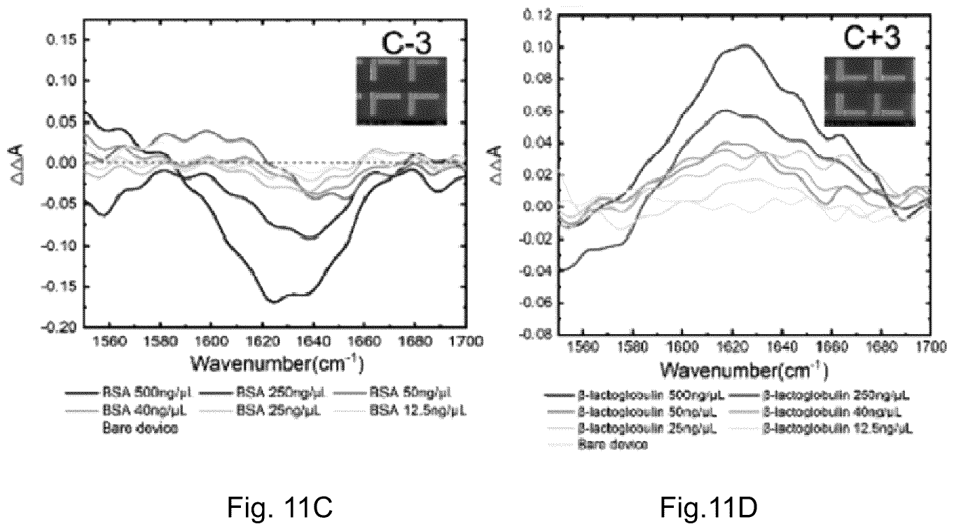

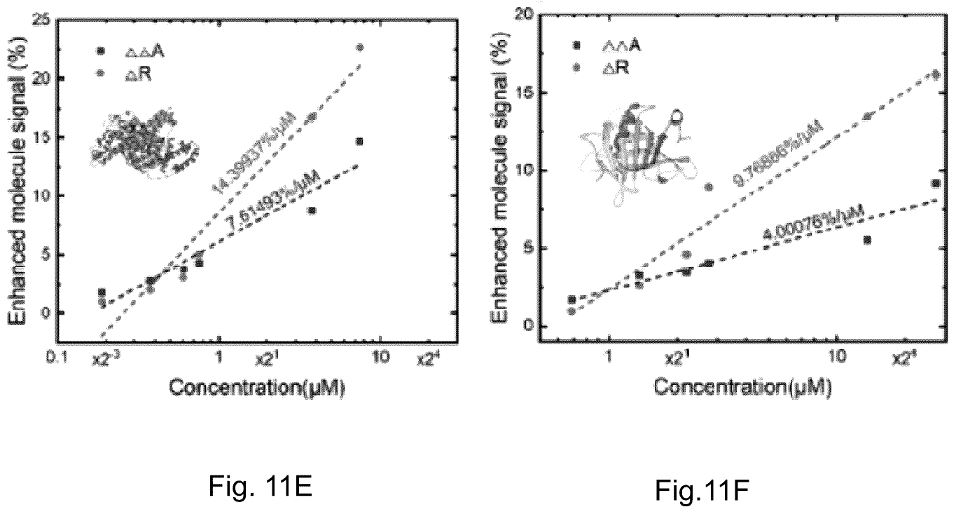

The IRCPM enhanced sensor can be used for the chirality determination of chiral molecules with different concentration. The concentration of BSA and β-lactoglobulin solutions was varied to demonstrate the limit of detection of the IRCPM enhanced sensor device. Such capability may be useful for quantitatively monitoring chemical synthesis processes. The C0 structure was used for SEIRA detection of both proteins, while C+3 and C−3 structures are used for the SEVCD spectrum of β-lactoglobulin and BSA, respectively. The detailed measurement results can be found in FIGS. 11A-11F. Both BSA and β-lactoglobulin solutions were prepared with 1000 ng/μL concentration and diluted with DI water to obtain 500 ng/μL, 250 ng/μL, 50 ng/μL, 40 ng/μL, 25 ng/μL, and 12.5 ng/μL concentrations. The same sample was used for the measurement of each concentration, with cleaning steps between each test to avoid signal interference. First the C0 structure was used for the detection of IR absorptive signals for varying concentrations, as shown in FIGS. 11A, 11B. For both proteins, the absorptive signal grew with increasing concentration at the molecule vibrational wavelengths. Even at the smallest concentration of 12.5 ng/μL, a signal contrast of around 0.015 can be observed with a small volume of 1 μL. Compared with traditional VCD signal for BSA and β-lactoglobulin, which required a concentration of 20 mg/100 μL to obtain a spectroscopy signal of 10⁻⁵ level, the current platform effectively enhances the molecule signal by 6 magnitudes. Moreover, this has not reached the detection limit of the device due to the intrinsic noise of the integrated laser setup. The results for SEVCD are shown in FIGS. 11C and 11D. The chiral response of BSA and β-lactoglobulin of opposite signs also showed an opposite chirality. The IR and CD signals were plotted with concentrations in FIGS. 11E, 11F. It can be observed that for both proteins, the increasing rate of SEIRA (14.39937%/μM and 9.76866%/μM) is larger than SEVCD (7.61493%/μM and 4.00076%/μM), indicating the advantage of using IR signals for quantified detection, where a maximum sensitivity of 14.39937%/μM is achieved for the SEIRA detection of BSA.

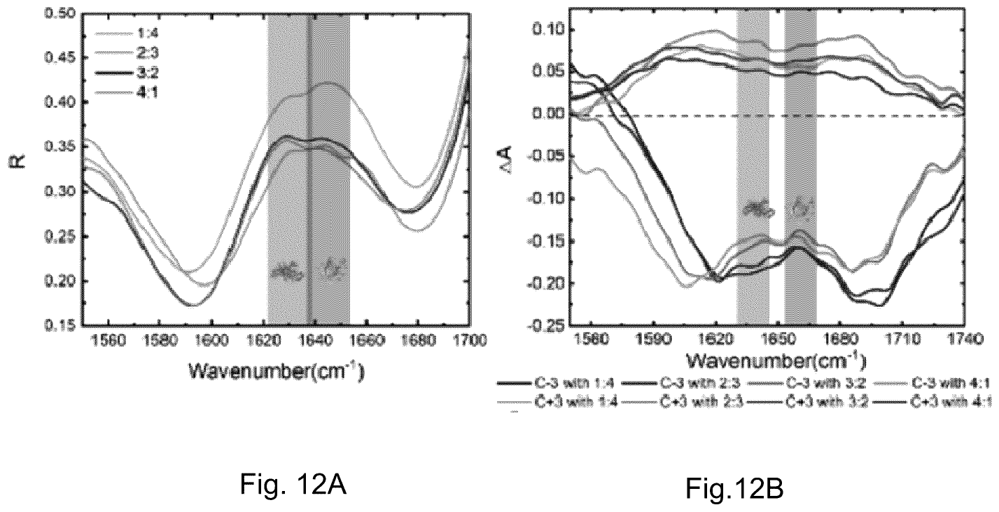

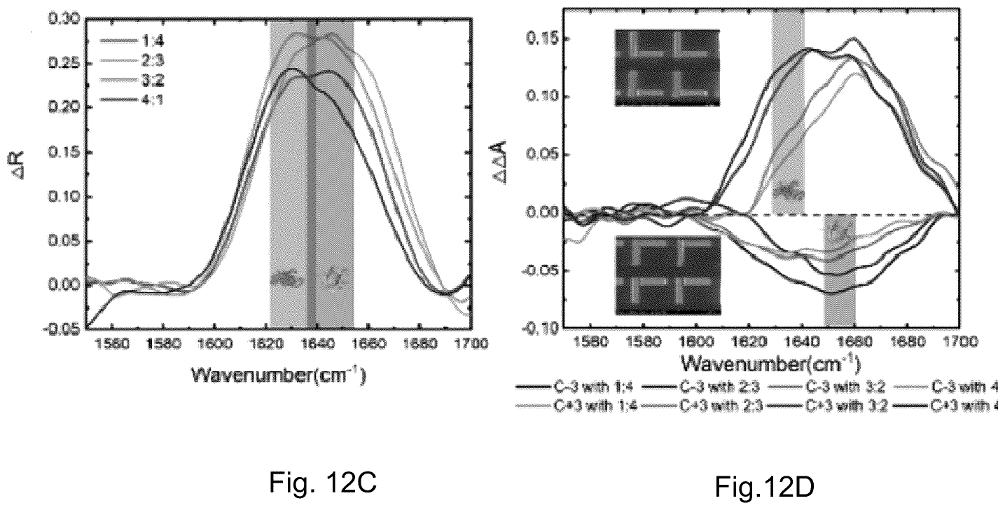

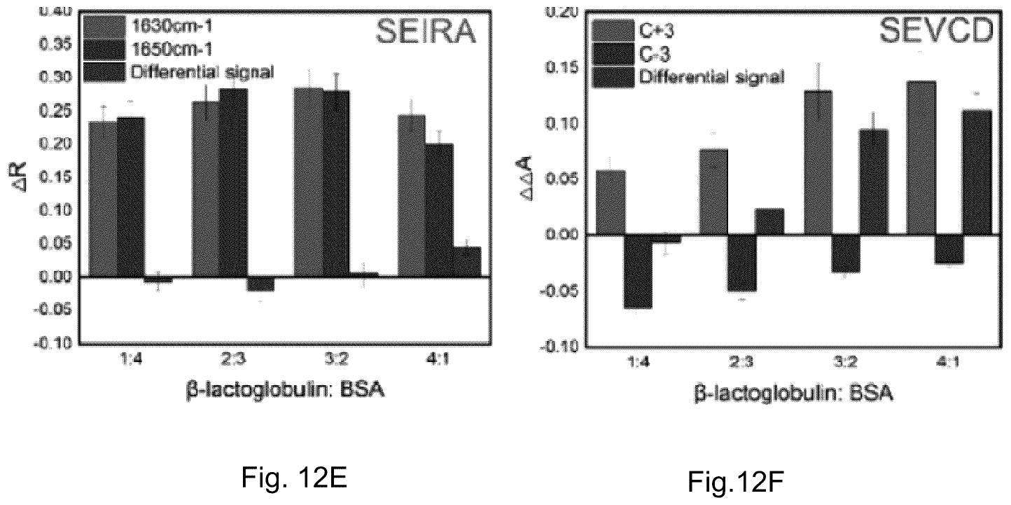

The IRCPM may further be used for the detection of chiral mixtures. The detection of mixed chiral compounds using the current metamaterials is possible. The ability of distinguishing different chiral structures in mixtures can have a wide range of applications for the chiral sensors, such as in the pharmaceutical industry, where chiral impurities lead to side effect or opposite effect in drug production. 10 μL of each BSA and β-lactoglobulin solutions of 250 ng/μL concentration were mixed into four different ratios, labeled 1:4, 2:3, 3:2, and 4:1, respectively. 2 μL of each solution were dropped onto the chiral metamaterials to detect the signal difference of each SEIRA and SEVCD spectra, as shown in FIGS. 12A-12F. For the IR spectrum, it is possible to visualize two closed reflection peaks at wavenumber 1630 cm⁻¹ and 1650 cm⁻¹, indicating the fingerprint of β-lactoglobulin and BSA molecules, respectively (FIG. 12A.). The ΔR signals were plotted for each protein and the signal difference calculated in FIGS. 12C, 12E. At this step, the identities of these two proteins are revealed according to the vibrational wavelength. However, the contrast of these two molecules regarding the mixed ratio is not high enough. For example, the signal even showed a decreased change when the ratio changed from 1:4 to 2:3. The reason for the abnormal signal may be because of the overlap between two wavenumbers. As the proposed IRCPM required a proper ratio between the absorption loss and the radiative, and the selectivity is determined by the absorption loss of the plasmonic structures, the sensitivity of closed wavelength ranges may be affected by the overlapped signals. The CD spectrum was applied for the mixed proteins' compounds, which expands its capability of differentiating the closed signals in the spectrum, as shown in FIGS. 12B, 12D, 12F. Leveraging the chiral structures mentioned above, the positive and negative chiral signals are distinguished and the intensities compared for each mixed ratio. As the molecule mass of β-lactoglobulin is larger than BSA, the signal of positive chiral structure is slightly larger than negative signals. From the shown differential data, the chirality showed an increased tendency from negative to positive as the BSA ratio becomes larger. This demonstration indicates that for the mixed chiral structure sensing, the platform can provide the SEIRA spectrum to identify the molecule without labels by specifying the IR absorption peaks, followed by the SEVCD spectrum to quantitatively determine the CD signals. Combining the two spectra, the chiral metamaterials can enable the detection of unlabeled chiral mixtures with similar absorption peaks at a closed ratio. Such demonstration indicates the potential for label-free detection of mixed molecules with similar IR fingerprints and different chirality. The proposed mid-IR chiral sensing platform can be used in various applications in drug delivery, biomedical detection, healthcare, and clinical diagnosis.

The above has described the use of a metamaterial based on a pair of perpendicular nanorods. A similar metamaterial may use two pairs of nanorods to provide a metamaterial that has a chiral structure but an achiral response. This metamaterial may be referred to as a quasi-achiral-metamatertial (QAM). Similar to the metamaterial described above with the in-plane and out-of-plane asymmetries, the two pairs of nanorods also have in-plane and out-of-plane asymmetries. The QAM may comprise a first pair of perpendicular nanorods and a second pair of perpendicular nanorods that are arranged to form a ring structure. It will be appreciated that the ring may be an R-ring or L-Ring.

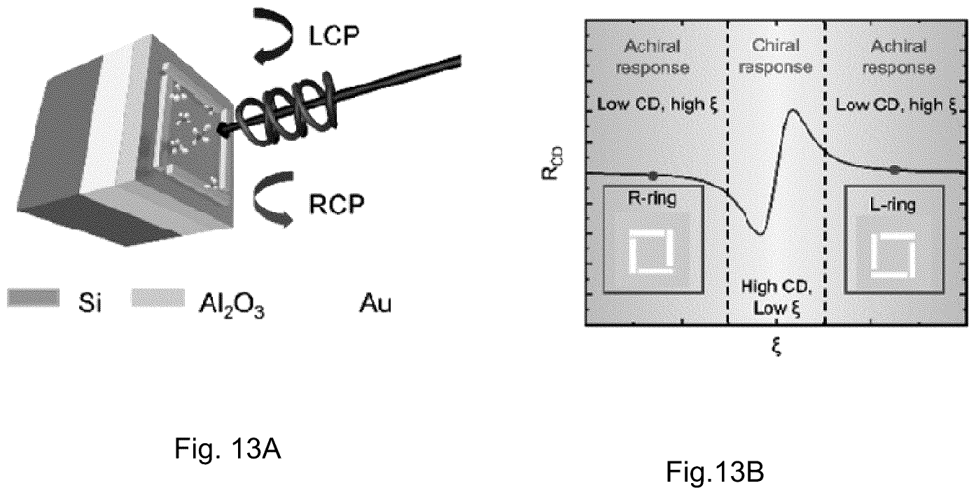

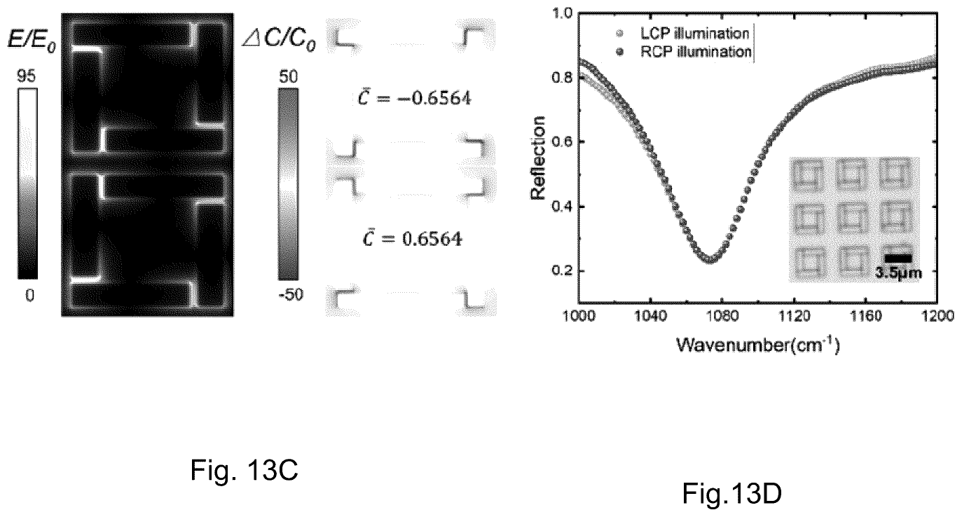

The motivation for developing such QAM structures is to remove the interference of the CD signal from metamaterials, which can improve the signal contrast of molecules, especially when the molecular signal is very weak. The schematic drawing of such a platform is shown in FIG. 13A, which depicts an R-ring. The design methodology is also from the proposed TCMT model as shown in Equation 7 above. The resonant frequency of x-oriented and y-oriented modes are assumed to be identical, and the expression can be written as:

$${R}_{CD} = \frac{4 ξ ( \frac{{γ}_{ay}}{{γ}_{ry}} - \frac{{γ}_{ax}}{{γ}_{rx}} ) {( {γ}_{rx} {γ}_{ry} )}^{\frac{3}{2}}}{{\vert {ξ}^{2} + [ {γ}_{rx} + {γ}_{ax} ] [ {γ}_{ry} + {γ}_{ay} ] \vert}^{2}} \qquad ( 13 )$$

Hence, the R_{CD} and ξ can be plotted as in FIG. 13B, while the value of other coefficients can be arbitrarily selected. From such plotted results, it is observed that the nanostructures can have the largest CD response when ξ is increased from zero to an extreme value, which is:

$${ξ}_{m} = \pm \sqrt{\frac{( {γ}_{rx} + {γ}_{ax} ) ( {γ}_{ry} + {γ}_{ay} )}{3}} \qquad ( 14 )$$

When the value exceeds this extreme value, the reflected CD response will decrease and gets close to zero CD response. Therefore, the design method duplicates the number of nanorods from 2 to 4, where the hotspots of each nanorod are close to one another for larger near-field interactions, such as the L-ring and R-ring structures. Compared with achiral nanostructures, these quasi-achiral structures provide not only enhanced field intensity but also larger differences in optical chiral field, as shown in FIG. 13C. Both L-ring and R-ring structures were fabricated for measurements. The LCP and RCP reflection response of the L-ring is shown in FIG. 13D, where only little differences can be observed, indicating the achiral response.

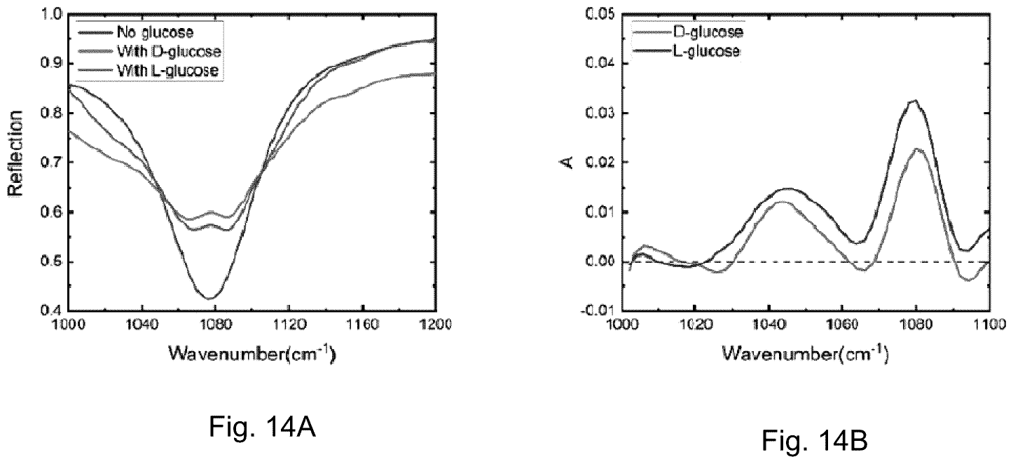

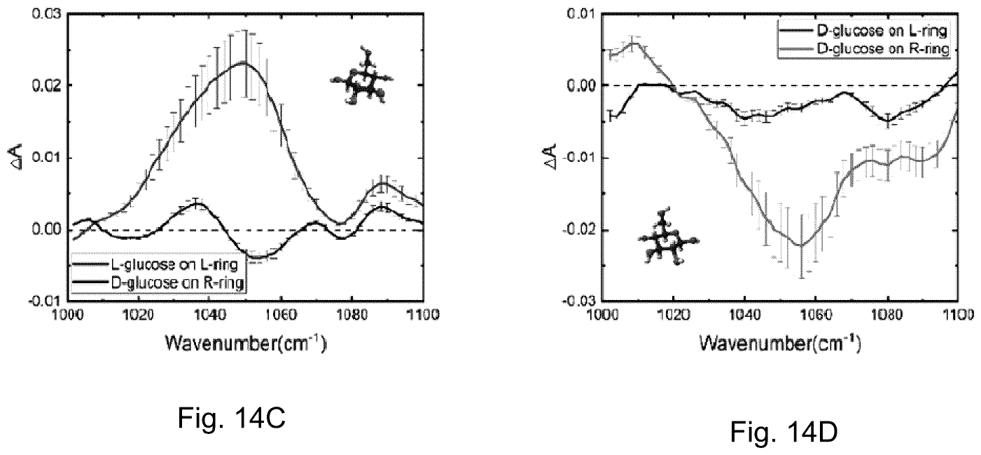

Leveraging the QAM structure, L-glucose and D-glucose was used to demonstrate the enhanced sensing performance. The L-glucose and D-glucose were dissolved in DI water to form diluted solutions, with a concentration of 1 mg/ml. L-glucose and D-glucose are enantiomers, which present identical chemical formulas but have different stereochemistry properties. As L-glucose is known as rare sugar and has been reported to be synthesized using D-glucose, it is important to distinguish them. However, it is difficult to tell the difference by only looking into the enhanced infrared spectra, as the vibrational peaks are identical, as shown in FIGS. 14A, 14B. The proposed QAM structures can be utilized for detecting the enhanced VCD signal in the differential absorption band, shown in FIGS. 14C, 14D. Different from the chiral metamaterials results as shown in FIGS. 9B-9E, the QAM nanostructures do not provide CD responses, and the total VCD signal is from the molecular CD only, which improves the signal contrast. The weak VCD signals of L-glucose and D-glucose can now be observed without removing the background of QAMs.

A further application is enantiomer sensing, such as glucose enantiomers. In such an application, a sensor formed from the quasi-achiral metamaterial is coated with L-glucose and D-glucose, and the weak VCD signals of glucose are enhanced without having to remove the background signal, which improves the signal contrast.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A metamaterial for use in a sensor comprising:
a substrate; and
a pair of nanorod resonators that work at mid-infrared wavelengths, each of the nanorod resonators of the pair of nanorod resonators arranged perpendicular to each other on the substrate, wherein the pair of nanorod resonators have an out-of-plane asymmetry in their geometric arrangement and an in-plane asymmetry in their geometric arrangement.

2. The metamaterial of claim 1, wherein the out-of-plane asymmetry is a difference in a height above the substrate of the nanorod resonators of the pair of nanorod resonators.

3. The metamaterial of claim 1, wherein the in-plane asymmetry is an offset of the relative location of the nanorod resonators of the pair of nanorod resonators.

4. The metamaterial of claim 1, wherein the substrate comprises:
a silicon (Si) layer;
a gold (Au) layer on the Si layer; and
an aluminum oxide (Al2O3) layer on the Au layer.

5. The metamaterial of claim 1, wherein the nanorod resonators are made from gold.

6. The metamaterial of claim 1, further comprising a second pair of nanorod resonators arranged to form a ring with the first pair of nanorod resonators.

7. A vibrational circular dichroism sensor comprising: a metamaterial of claim 1, wherein the in-plane and out-of-plane asymmetries of the metamaterial provide asymmetric absorption of circularly polarized light.

8. A vibrational circular dichroism sensor comprising: a metamaterial of claim 6, wherein the first and second pairs of the nanorod resonators of the metamaterial provide a near-zero circular dichroism response.

9. Use of a vibrational circular dichroism sensor of claim 7 for protein secondary structure sensing and chiral mixture sensing.

10. Use of a vibrational circular dichroism sensor of claim 8 for enantiomer sensing.
